(19) United States
(12) Patent Application Publication
(10) Pub. No.: US 2012/0256763 A1
(43) Pub. Date: Oct. 11, 2012

(54) Remote Machine Query and Control Using Telemetry Unit and Other Sensors

(75) Inventors: Gerald R. Johnson, Hesston, KS (US); Timothy Dan Buhler, Newton, KS (US); Grant L. Good, Moundridge, KS (US)

(73) Assignee: AGCO CORPORATION, Duluth, GA (US)

(21) Appl. No.: 13/416,191

(22) Filed: Mar. 9, 2012

Related U.S. Application Data
(60) Provisional application No. 61/451,174, filed on Mar. 10, 2011.

(51) Int. Cl. G08C 19/00

(52) U.S. Cl. 340/870.07

(57) ABSTRACT

Systems and methods for remote query and control of an agricultural machine use an onboard telemetry unit as a gateway for communication with the machine. The telemetry unit can be coupled to both the machine's electrical system at the machine, and a machine's controller area network (CAN). A user can call up the machine's telemetry unit using a cell phone, personal computer, or other remote communication device. In response, output from the telemetry unit can be used to energize the CAN through the vehicle's electrical system. Once energized, the CAN is able to receive commands from a user through the telemetry unit and provide them to control nodes of various machine apparatus and devices via the CAN communications bus.

### CROSS-REFERENCE TO RELATED APPLICATIONS

This Application claims priority to U.S. Provisional Application No. 61/451,174 filed Mar. 10, 2011, entitled “Remote Machine Query and Control Using Telemetry Unit and Other Sensors.”

### FIELD OF INVENTION

This invention pertains generally to methods and systems for supporting agricultural operations, and more particularly to remote machine operations using telemetry.

### BACKGROUND OF INVENTION

In general, remote operation of consumer devices has primarily focused on the use of radio waves from a relatively proximate, typically line-of-sight source. Manipulating a remote-controlled airplane, robot and the like, or unlocking a car with a key fob device, immediately come to mind as common examples of remote device operations. In such applications, a small transmitter in a control device can generate a signal that can be detected at a receiver at the controlled device. Power and frequency constraints reduce the likelihood of interference at the device receiver, as well as limit the operational range between the device and its controller.

In the context of vehicles, the concept of remotely controlling some aspect of an automobile has been further expanded in the development of user assistance systems such as ONSTAR®, which offers subscription services, such as emergency road service and navigation assistance. A user can depress a button at an onboard ONSTAR® console to connect with a customer service operator who can coordinate the assistance of emergency personnel, or the transmission of signals to unlock a vehicle. In the event of an accident, an onboard device can connect with an ONSTAR® center to prompt a customer service representative to call the vehicle to check on the condition of the passengers.

In general, the ONSTAR® system relies on dedicated proprietary equipment and third party personnel to remotely facilitate select vehicle-related services for subscribers. A triggering condition at the vehicle, such as an airbag deployment, or user input, can activate an ONSTAR® device to call a service representative who can perform some vehicle-related action on behalf of the subscriber, who is typically at the vehicle.

While adequate for its intended purposes, there are needs that the ONSTAR® system, and others of its ilk, fails to address. For instance, there can be a need to perform a remote operation on an unattended vehicle, or on a vehicle that is turned off. Such needs can be particularly acute in the context of agricultural machines, vehicles for which operation can be constrained by economic, regulatory, and environmental restrictions.

Due to the nature of agricultural work, machines are often parked in fields or shelters overnight that can be quite a distance from an operator's residence or a fleet manager's back office. Operators living and working in northern climates often encounter difficulties when attempting to start a machine engine in the low temperatures that often prevail during the fall and winter seasons. To avoid the frustration and lost revenue that can result when an engine fails to start, heating blocks are often used to warm an engine. Typically the blocks are plugged in and left on overnight so that the engine can start quickly when the operator reports for work in the morning. However, studies indicates that leaving engine blocks turned on for more than 4 hours is a waste of energy, as the electric consumption of the blocks remains the same but the resulting increase in temperature for the engine and/or oil falls off dramatically. Furthermore, in those cases in which a machine is to be parked for several days, an operator is often forced to make a special trip to the machine just to turn on or plug in the engine blocks to warm the engine for the following day. There is a need for a means by which an operator can turn on engine blocks at a machine that is turned off.

As a further example, an agricultural machine can often be parked outside in a field. Because operators can be compelled to conduct certain operations in darkness, it would be advantageous for the operator to have the ability to turn on the machine lights as he is approaching the machine. Other examples can include, but not be limited to, performing machine diagnostic procedures and remotely starting a vehicle. Thus, it would behoove the owner, fleet manager, or operator of an agricultural machine to have the ability to remotely query, or control an unattended agricultural machine that is parked and turned off. Because different operators may desire different types of information/operations depending on his work schedule, there is a need for a common method that can be used by multiple operators to perform a variety of operations for vehicles at remote locations. There is a need for a method and system that allows an operator or fleet manager to directly control a machine in order to better perform his particular work assignment, without requiring the services of a third party, whose intervention can both delay operations and increase costs. There is a need for a system and method for remote sensing and operations that can be implemented throughout a machine fleet without significant investment in new equipment. There is further a need for a system and method for remote operations that can be implemented on legacy machines without the need for expensive retrofitting procedures.

### BRIEF DESCRIPTION OF THE DRAWINGS

FIG. 1 shows an example system of the invention.

FIG. 2 shows an example system of the invention.

FIG. 3 shows an example system of the invention.

FIG. 4 shows a flow diagram of an example method of the invention.

FIG. 5 shows a flow diagram of an example method of the invention.

### OVERVIEW

A system for remote query and control of an agricultural vehicle can include a gateway interface module (GIM) configured for electrical coupling to an agricultural machine, and a user communication device configured for communication with the GIM over a communications network. In an example embodiment, the GIM can include a telemetry unit and a multiplexing module configured to couple the telemetry unit to a power circuit for a controller area network (CAN). The GIM can be configured to function as a gateway for communication with the CAN. A user can communicate with the telemetry unit over the communications network, and a telemetry output can be used to energize or “wake up” the CAN, thereby enabling remote query and control of various devices at the machine. In an example embodiment, the multiplexing module is configured to enable power from a power source to be provided to the CAN.

Many agricultural machines are equipped with a telemetry unit for the recordation and one-way transmission of machine data from the machine to a back office while a machine is turned on. A GIM enables a currently installed telemetry unit to be used for bidirectional communication with a machine, facilitating remote query and control directly by an operator or fleet manager. A system of the invention enables remote control of the machine while it is in an OFF state. The invention provides a communication gateway that does not require dedicated equipment or costly retrofitting operations. A system and method of the invention enable direct communication between a user and his machine, without the need for third party intervention or subscription fees.

### DETAILED DESCRIPTION OF EXAMPLE EMBODIMENTS

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the example embodiments are discussed in the context of an agricultural vehicle, it will be understood that the present invention is not limited to that particular arrangement. Likewise functions discussed in the context of being performed by a particular module or device may be performed by a different module or device, or combined, without departing from the scope of the claims.

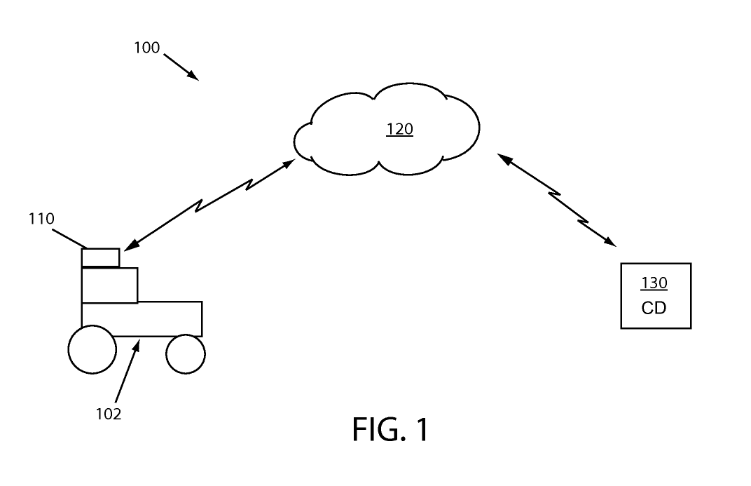

Turning now to the figures, the present invention will be described in detail. Referring to FIG. 1, a system 100 for remote query and control can include an agricultural machine 102 equipped with a gateway interface module (GIM) 110 coupled to the agricultural machine, and configured to communicate with a user device 130 via a communications network 120. In an example embodiment, the user device 130 can be in the form of a cell phone, and the network 120 can include a cellular network, enabling an operator to directly call up the GIM 110. In a further embodiment, the user device 130 can be in the form of a personal computer equipped with a modem, so that a fleet manager can contact the agricultural vehicle 102 from a back office location using the internet. The GIM 110 can be configured to serve as a gateway to the machine 102 using its existing communication architecture, to enable remote control and query by directly by user associated with the machine. No third party intermediary is required in order for an operator or manager to query or conduct remote operations at the machine 102.

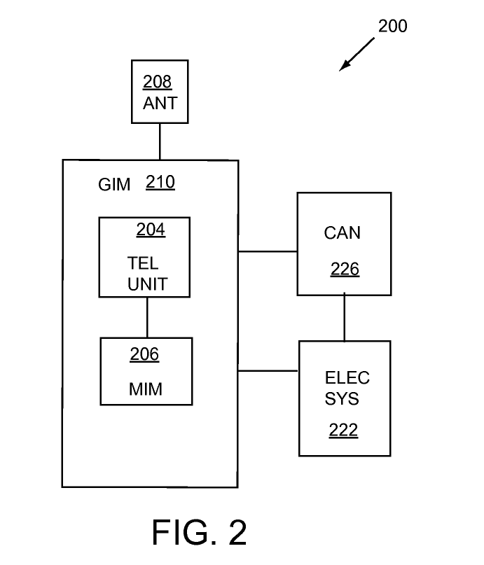

FIG. 2 depicts an example system 200 for remote query and control. The system 200 can include a GIM 210 that includes a telemetry unit 204 coupled to a multiplexing interface module (MIM) 206. In an example embodiment, the telemetry unit 204 is embodied as a telematics device configured for use on an agricultural machine. In an example embodiment, the telemetry unit 204 can include a modem, such as a GPRS modem configured for communication over a cellular network. The telemetry unit 204 can be coupled to an antenna 208 for transmission and reception of signals. In an example embodiment, the antenna 208 is a combined GPS and GPRS antenna, enabling reception of satellite signals for geo-positioning as well as communication signals over a cellular network. In an example embodiment, the telemetry unit 204 can include a power supply, such as a battery, enabling its operation even when the host machine is turned OFF.

The MIM 206 can provide an interface between the telemetry unit 204 and a machine's controller area network (CAN) 226 via its electrical system 222 which can include a machine's battery, and can include the software, hardware and/or firmware required to adequately interface for enabling remote query and control operations. In an example embodiment, the CAN 226 is a controller area network as known in the art as a multi-master short message broadcast system based on an International Standardization Organization (ISO) defined serial communications bus (for example, ISO 11898 standard). Originally developed by Bosch for the automotive industry, the use of CAN systems has expanded to include automation, medical and manufacturing applications.

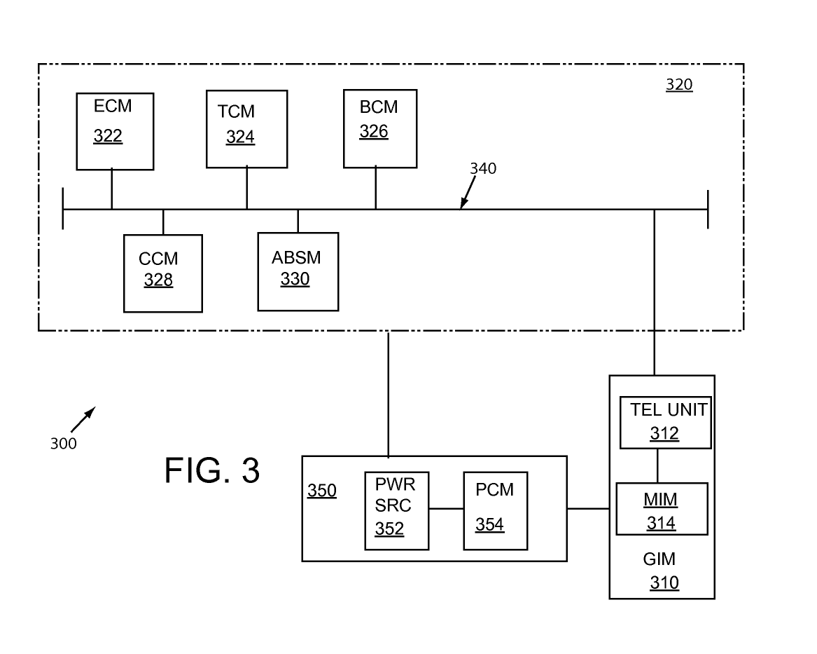

FIG. 3 shows an example system 300 that can be used to facilitate remote query and operation of the machine 102. The system 300 can include a GIM 310 coupled to a CAN 320 that can include several nodes, such as but not limited to: an engine control module (ECM) 322, a transmission control module (TCM) 324, a body control module (BCM) 326, a climate control module (CCM) 328, and an anti-lock braking system module (ABSM) 330. Each node can comprise a transceiver (also referred to as a CAN controller) configured to transmit and receive messages over a serial communications bus 340 to which each node is coupled. In addition, each node can comprise a host processor coupled to the CAN controller and configured for composing messages to be transmitted, and for determining content of messages received. In an example embodiment, one or more sensors, actuators, control device or other apparatus can be coupled to the host processor.

Each CAN node requires power for its processing and communication operations. FIG. 3 shows a power circuit 350 configured to provide power to the CAN 320. In an example embodiment, the power circuit 350 is part of the machine's electrical system. The power circuit 350 can include, but not be limited to, a power source 352, which in an example embodiment, can be coupled to a power control module (PCM) 354. In an example embodiment, the power source 352 is embodied as a battery, for example, a machine battery used to charge a starter motor, lights and ignition system of the machine. In a further example, a separate battery at the machine can be used to power the CAN 320. While the machine or vehicle is turned on, its charging system can charge its battery. However, when the vehicle is turned OFF, the charging system no longer operates. To prevent the CAN 320 from draining a machine battery while a machine is turned OFF, the power control module 354 can be coupled to the power source 352 and configured to control power provided to the CAN 320. For example, the PCM 354 can comprise a power relay that can switch power to the CAN 320 from the power source 352 on or off. In an example embodiment, a power relay circuit, such as a phase panel relay, can be coupled to the machine's ignition system so that power is provided to the CAN 320 when the ignition is turned on, and switched off when the ignition is turned off. In another example, a PCM can further include a power controller device such as, but not limited to, a CAN user console, configured to enable or prevent battery power to be provided to the CAN 320. In an example embodiment, the power control module 354 is part of the electrical system for the machine 102, and a GIM of the invention can be configured to couple with an existing power control module of a machine's electrical system, reducing the number of parts required in order to install and implement the invention on a legacy machine.

A further configuration for conserving energy includes a CAN configured to enter a standby or sleep mode when a vehicle or machine engine is turned OFF. For example, in a standby mode, a node transceiver can be configured to operate in a “listen only” mode, where driver (transmitter) circuitry is OFF while receiver circuitry can continue to monitor bus activity. In a sleep mode, both receiving and transmitting circuitry at the node transceiver can be turned off. In an example embodiment, a sleep signal or standby signal can be sent to CAN nodes when the vehicle is turned off, and a wake signal can be sent when the vehicle or machine is turned on. For example, the power control module 354 can be configured to send sleep or stand-by signals in response to an ignition OFF signal.

The GIM 310 can include a telemetry unit 312. In an example embodiment, the telemetry unit 312 is configured for bidirectional communication, having the software and hardware required for communication with a user device such as a cell phone or personal computer over the communications network 120. The telemetry unit 312 can be configured with CAN high and CAN low ports for electrical coupling to the CAN 320, and can include the hardware, software, or firmware necessary to enable the telemetry unit to function as a CAN node, sending and receiving messages to and from other CAN nodes via the CAN bus 340. In an example embodiment, the telemetry unit 312 can be configured for coupling to a MIM 314 that can interface with a machine's electrical system. For example, the telemetry unit 312 can include an output port that can be coupled to the MIM 314. In an example embodiment, telemetry output drives the MIM 314 to enable power to be provided to the CAN 320. The telemetry unit 312 can include hardware, software, and or firmware configured to drive an output at its output port in response to receiving communication from the user device 130.

In an example embodiment, the MIM 314 can be configured for coupling to the power circuit 350. In an example embodiment, the MIM 314 can be configured to interface with the PCM 354 to control power provided to the CAN 320 from the power source 350. For example, the PCM 352 can comprise a phase panel relay, and the MIM 314 can comprise a diode connected to the phase panel relay. Output from the telemetry unit 312 can be used to drive the diode so that power from the power source 352 is provided to the CAN 320. In a further embodiment, rather than coupling to a power control module previously present at the machine, an MIM of the invention can include a power relay circuit that can be coupled to the power source 352 and the CAN 320 so that power can be provided to the CAN 320 in response to telemetry unit 312 output.

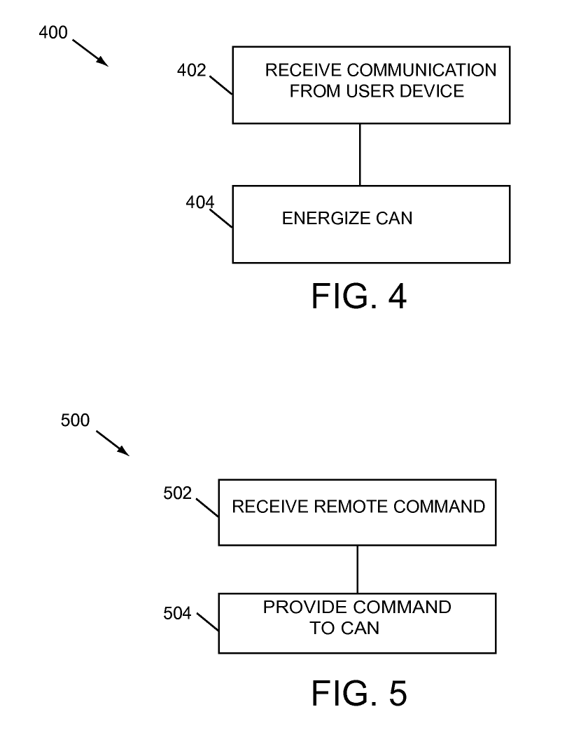

FIG. 4 shows a flow diagram of an example method 400 that can be used for remote query and control of a machine. At block 402, the GIM 310 can receive communication from a user device. In an example method, an operator can use a cell phone to communicate with the telemetry unit 312 of the GIM 310 over the communications network 120, and the telemetry unit 312 can receive the cell phone signal. The communication signal can be detected at the antenna 208 and provided to the telemetry unit 312 that is configured with the software, hardware and/or firmware to receive the communication signal and generate a response. As another example, a fleet manager can contact the telemetry unit 312 via a laptop at a back office, using a communications network that includes packet-switched and cellular communications.

At block 404, the telemetry unit 312 can energize a CAN at the machine 102 in response to the received communication. Energizing the CAN enables communication among the CAN nodes, and enables the telemetry unit to send and receive messages via the CAN bus. In an example embodiment, a telemetry unit output can be provided to an electrical system at the machine in order to energize the CAN. For example, the telemetry unit 312 can provide an output to the MIM 314 to drive the power circuit 350 to provide power to the CAN 320.

FIG. 5 shows an example method 500 for remote control of a machine. At block 502 a telemetry unit can receive a remote command. For example, an operator can use a cell phone to convey the command to turn on the lights. The cell phone can make initial contact with the machine and allow user input to provide the command, either through voice or through the keypad. If the CAN system is powered down, for example, when the vehicle is parked and turned off, then reception of the cellular signal can cause the GIM 310 to power up the CAN, as described in method 400. In a further embodiment, the CAN can be powered on, for example, the machine can be working in a field, and a fleet manager can call up the telemetry unit 312 either by cell phone or via the internet using a laptop computer or smart phone to query the machine 102.

The telemetry unit 312 can include ports configured for coupling to the CAN 320, typically used to receive sensor data that is transmitted to a fleet management back office. However, as a fully functional CAN node, it can both receive data from and provide data to the CAN bus 340. In the present system, a telemetry unit can receive user commands for remote operations or querying, and provide the command to the CAN, as shown in block 504. For example, the telemetry unit 312 can transmit the commands to the CAN bus 340. The GIM 310 can include the software, hardware and/or firmware required to perform any necessary translation or formatting of signal information received over the cell phone, or other communication device, to a format compatible with the communication standards of the CAN 320. The node associated with the apparatus that is subject to the command can then receive the command and perform the required task. For example, a user can request that engine block heaters be turned on. The GIM 310 can receive the command request, format a message to that effect, and provide the message to the CAN bus 340, which can deliver to the BCM 326 (or other appropriate node) to perform the task.

In a similar manner, energizing a CAN can comprise waking a CAN that is in a stand-by or some reduced operational state. Because the telemetry unit 312 can be configured with its own battery or power supply, it has the power to operate as a gateway and a fully functional node in the CAN 320 while the other nodes are in a standby state. To prevent draining the battery while vehicle ignition is off, the PCM 354 can be configured to switch power off again, for example: after a predetermined time interval, or if no messages from the telemetry unit are received within a predetermined time period, or by satisfaction of any other predetermined condition or parameter.

Thus the present invention provides systems and methods for the remote query and control of an agricultural machine using an onboard telemetry unit as a gateway for communication. Cell phones can be used to “dial up” machinery, energize its CAN system, and send commands to it such as turn on or off lights, or activate an engine block heater. Laptops or PC's can be used to communicate remotely through the telemetry device for remote diagnostics, current status or to read available sensors and report information. The invention can be practiced without requiring third party intervention, costly investment in new equipment or expensive retrofitting operations.

1. A system for remote query and control of a machine, comprising:
a gateway interface module (GIM) configured to energize a machine controller area network (CAN) of a vehicle in response to communication from a remote communication device.

2. The system of claim 1, wherein said GIM comprises a telemetry unit.

3. The system of claim 1, wherein a telemetry unit is configured to function as a gateway to said CAN.

4. The system of claim 1, wherein said GIM comprises a multiplexing interface module (MIM) configured for coupling to a telemetry unit and to a power circuit for said CAN.

5. The system of claim 4, wherein said MIM is configured to couple a power source to said CAN.

6. The system of claim 5, wherein said power source comprises a machine battery.

7. The system of claim 4, wherein said MIM comprises a diode configured for operation in a phase panel relay configured to provide power to said CAN, and wherein a telemetry unit output drives said diode to turn on power to said CAN.

8. The system of claim 4, wherein said power circuit is part of an electrical system for said machine.

9. The system of claim 1, further comprising a remote user communication device, wherein said remote user communication device is configured for communication over a cellular communications network.

10. The system of claim 1, wherein said machine comprises an agricultural machine.

11. The system of claim 1, wherein said GIM is configured to receive a remote control command via said user device.

12. The system of claim 11, wherein said GIM is configured to provide said remote control command to said CAN.

13. The system of claim 12, wherein said remote control command comprises turning on machine lights.

14. The system of claim 12, wherein said remote control command comprises turning on an engine block heater.

15. A system for enabling remote query and control at a vehicle, comprising:
a telemetry unit configured for bidirectional communication; and
a multiplexing interface module (MIM) configured for coupling to said telemetry unit and to an electrical system for said vehicle; and
wherein said system is configured to energize a controller area network (CAN) at said vehicle.

16. The system of claim 15, wherein said telemetry unit is configured to function as a gateway to said CAN.

17. The system of 15, wherein an output from said telemetry unit is configured to drive said MIM to energize said CAN.

18. The system of claim 17, wherein said telemetry unit provides said output in response to receiving communication from a user communication device.

19. The system of claim 18, wherein said MIM is configured to enable power from a power source to be provided to said CAN.

20. The system of claim 19, wherein said MIM comprises a diode in a power relay circuit configured to switch on power from a power source to said CAN.

21. The system of claim 20, wherein said power source comprises a battery at said vehicle.

22. The system of claim 19, wherein said vehicle comprises an agricultural machine.

23. An apparatus, comprising a means for energizing a controller area network (CAN) on an agricultural machine, said means configured to use a telemetry output to provide power to said CAN from a power source at said machine.

24. The apparatus of claim 23, wherein said means comprises a diode in a phase panel relay configured to power up said CAN.

25. The apparatus of claim 23, wherein said telemetry output is provided in response to receiving a communication signal from a user communication device.

26. The apparatus of claim 23, wherein said power source comprises a battery.

27. The apparatus of claim 23, wherein said means is further configured to transmit and receive messages over a communications bus for said CAN.

28. A method for remote query and control, comprising:
receiving communication from a remote user communication device at a vehicle telemetry unit; and
in response to said communication, energizing a controller area network (CAN) at said vehicle.

29. The method of claim 28, wherein said energizing said CAN comprises providing an output to an electrical circuit coupled to said CAN.

30. The method of claim 29, wherein said providing an output to an electrical circuit comprises providing an output used to drive a power circuit configured to couple a power source to said CAN.

31. The method of claim 28, wherein said energizing said CAN comprises enabling power to be provided to said CAN.

32. The method of claim 29, wherein said providing an output comprises providing an output to a multiplexing interface module (MIM) coupled to a power circuit at said vehicle.

33. The method of claim 32, wherein said MIM comprises a diode configured for operation in a power relay to enable power to be provided to said CAN.

34. The method of claim 33, wherein said power is provided by said vehicle battery.

35. The method of claim 28, wherein said vehicle comprises an agricultural machine.

36. The method of claim 28, further comprising providing a message to said CAN in response to receiving a command from said user device.

37. The method of claim 36, wherein said message is configured to implement said command.
